(19) United States
(12) Patent Application Publication
(10) Pub. No.: US 2025/0276606 A1
(43) Pub. Date: Sep. 4, 2025

(54) ELECTRICITY-DRIVEN VEHICLE

(71) Applicants: TOYOTA JIDOSHA KABUSHIKI KAISHA, Aichi-ken (JP); ISUZU MOTORS LIMITED, Kanagawa (JP)

(72) Inventors: Masayoshi WATANABE, Nagoya-shi (JP); Kan SAITO, Ikeda-shi (JP); Toshiya TSUJITA, Ikeda-shi (JP); Naohiro NAKAMURA, Ikeda-shi (JP); Yasuo KAWAMOTO, Ikeda-shi (JP); Hideki OGAMI, Ikeda-shi (JP)

(21) Appl. No.: 19/063,294

(22) Filed: Feb. 26, 2025

(30) Foreign Application Priority Data
Feb. 29, 2024 (JP) 2024-029867

(51) Int. Cl. B60L 53/80; B60K 1/04; B60L 50/60; B62D 25/02; B62D 25/20; H01M 50/204; H01M 50/242; H01M 50/249; H01M 50/271

(52) U.S. Cl. CPC B60L 53/80; B60K 1/04; B60L 50/66; B62D 25/025; B62D 25/20; H01M 50/204; H01M 50/242; H01M 50/249; H01M 50/271; B60K 2001/0438; H01M 2220/20

(57) ABSTRACT

An electricity-driven vehicle includes: a floor panel; a deck board; a battery loading portion; one or more batteries of a replaceable type, that are inserted into and removed from the battery loading portion from a side of the vehicle; a loading port; and a lid that opens and closes the loading port. A marginal region is present between one end of the floor panel in a vehicle width direction, and the loading port. The deck board includes: a deck board body; and an overhang portion which extends to an outer side in the vehicle width direction in relation to the battery loading portion, so as to cover the marginal region from above the marginal region. The overhang portion is movable to a retracted position at which an area above the marginal region is opened.

### CROSS REFERENCE TO RELATED APPLICATION

This application claims priority to Japanese Patent Application No. 2024-029867 filed on Feb. 29, 2024, which is incorporated herein by reference in its entirety including the specification, claims, drawings, and abstract.

### TECHNICAL FIELD

The present disclosure relates to an electricity-driven vehicle, equipped with a replaceable battery.

### BACKGROUND

In the related art, an electricity-driven vehicle is widely known, in which a motor which is a motive power source, and a battery which supplies electric power to the motor are provided on a vehicle. The battery equipped in the electricity-driven vehicle is a secondary battery which can be charged and discharged, and is charged by an external power source as necessary.

A configuration is being proposed which employs a replaceable battery, which can be attached to and detached from the electricity-driven vehicle, in order to effectively utilize the electricity-driven vehicle even during charging of the battery. In a structure with a replaceable battery, when a state of charge of the battery equipped on the electricity-driven vehicle becomes low, the battery is removed from the electricity-driven vehicle, and is replaced with another battery which is charged in advance. The battery which is removed from the electricity-driven vehicle is then charged outside the electricity-driven vehicle. Because the electricity-driven vehicle can travel even during the charging of the removed battery, the electricity-driven vehicle can be more effectively utilized.

JP 2012-151916 A discloses a technique in which a replaceable battery is placed at a lower side of a floor panel of a vehicle. In the technique of JP 2012-151916 A, a loading port of the battery is positioned at an end of the electricity-driven vehicle in a vehicle width direction. In this case, when the vehicle collides at the side, impact of the collision is immediately input to the battery, and, thus, the battery may be damaged. Thus, a configuration may be considered in which a slight marginal region is provided between the loading port of the battery and the end of the vehicle in the vehicle width direction.

Normally, a panel member which is called a floor panel or a deck board is placed at an upper side of the battery. When the marginal region is covered by the panel member from above the marginal region, it becomes more difficult for the user to view a periphery of the loading port, resulting in reduction of workability of the battery replacement. On the other hand, if a portion of the panel member which overlaps the marginal region is cut out, because baggage cannot be loaded at the cut-out portion, a loading efficiency of the baggage is reduced.

An advantage of the present disclosure lies in provision of an electricity-driven vehicle which can achieve both superior loading efficiency of the baggage and superior workability of replacement of the battery.

### SUMMARY

According to one aspect of the present disclosure, there is provided an electricity-driven vehicle comprising: a floor panel; a deck board that is placed at an upper side of the floor panel; a battery loading portion that is placed between the floor panel and the deck board; one or more batteries of a replaceable type, that are inserted into and removed from the battery loading portion from a side of the vehicle; a loading port that is provided at one end of the battery loading portion in a vehicle width direction; and a lid that opens and closes the loading port, wherein a marginal region is present between one end of the floor panel in the vehicle width direction and the loading port, the deck board comprises: a deck board body; and an overhang portion which is placed at one end of the deck board in the vehicle width direction, and which extends to an outer side in the vehicle width direction in relation to the battery loading portion, so as to cover the marginal region from above the marginal region, and the overhang portion is movable to a retracted position in which an area above the marginal region is opened.

With the above-described structure, because baggage can be loaded also above the marginal region, the loading efficiency of the baggage is improved. In addition, with the overhang portion being moved to the retracted position, the battery can be easily replaced without the field of view being obstructed by the overhang portion.

In this case, the electricity-driven vehicle may further comprise a pair of side members that are placed with a spacing in the vehicle width direction, the battery loading portion may be placed within a width between the pair of side members, and the lid may open the loading port by swinging downward about an axis near a lower end of the loading port.

By employing a configuration in which the lid swings downward when the loading port is opened, obstruction of the field of view of the user by the lid when the lid is opened can be prevented. As a result, the user can easily replace the battery.

The overhang portion may move to the retracted position by sliding in a direction of a plane of the deck board.

According to the above-described structure, the overhang portion can be moved to the retracted position even in a state in which a part of the baggage is loaded on the overhang portion. As a result, the user can more easily replace the battery.

The overhang portion may be connected to the deck board body in a swingable manner, and may move to the retracted position by swinging upward.

With the above-described structure, the structure of the overhang portion can be simplified.

The deck board may further comprise a support member which is formed from a rigid structure, and which supports the overhang portion from below the overhang portion.

With the above-described structure, deformation of the overhang portion can be effectively prevented, and, thus, baggage can be stably disposed on the overhang portion.

According to an aspect of the present disclosure, superior loading efficiency of the baggage and superior workability of replacement of the battery can both be achieved.

### BRIEF DESCRIPTION OF DRAWINGS

Embodiment(s) of the present disclosure will be described based on the following figures, wherein:

FIG. 1 is a perspective diagram showing a region near a rear side door of an electricity-driven vehicle, viewed from outside the vehicle;

FIG. 2 is a schematic plan view of the electricity-driven vehicle;

FIG. 3 is a cross-sectional diagram along an A-A line of FIG. 2;

FIG. 4 is a cross-sectional diagram along a B-B line of FIG. 2;

FIG. 5 is a schematic diagram showing a relative placement of a deck board and a battery loading portion; and

FIG. 6 is a diagram showing another example of the deck board.

### DESCRIPTION OF EMBODIMENTS

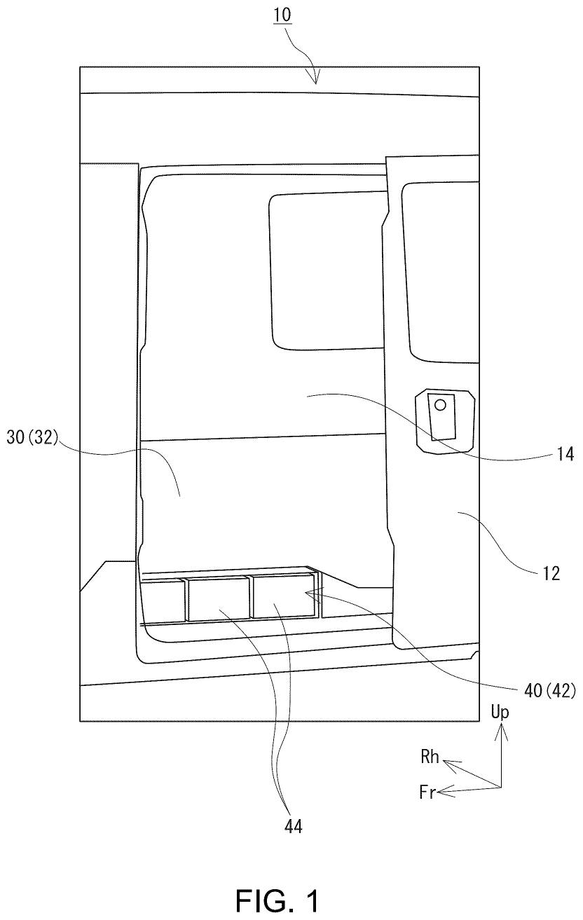

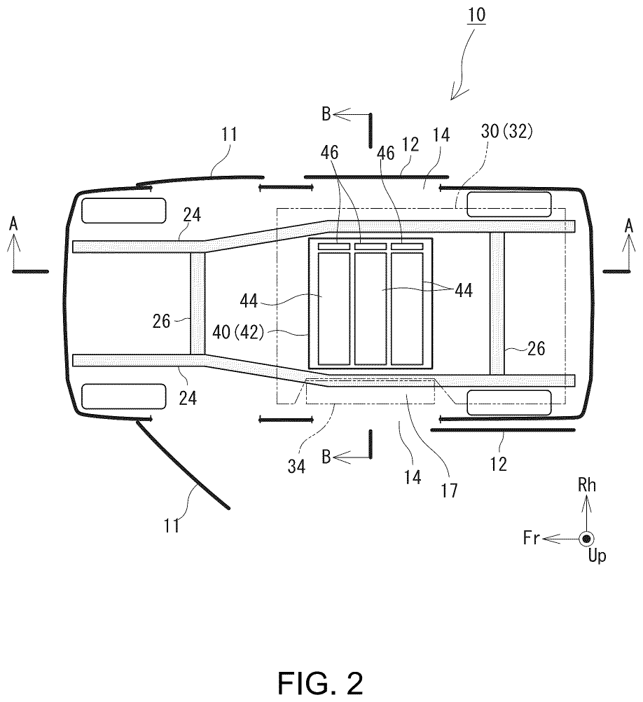

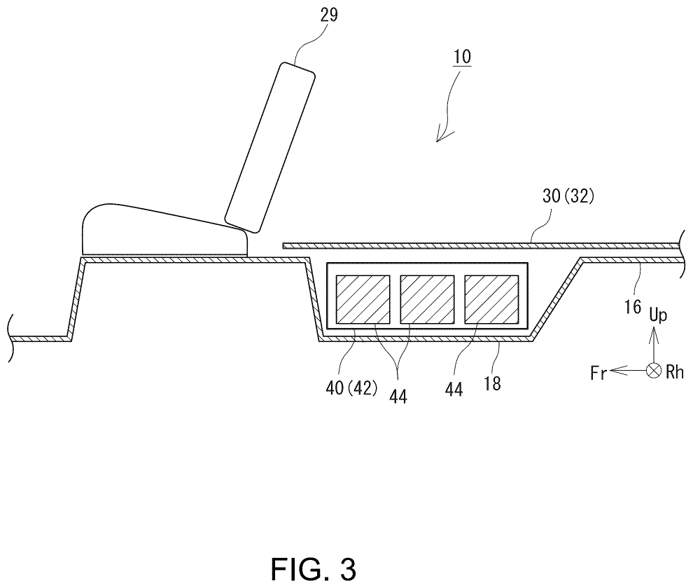

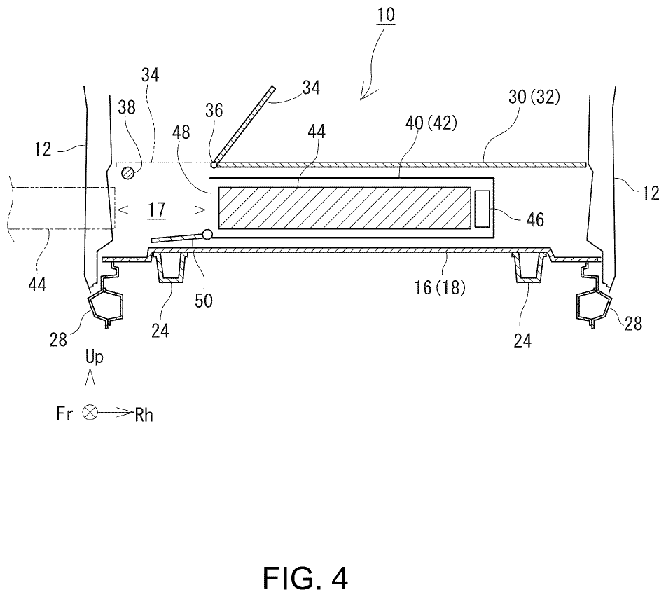

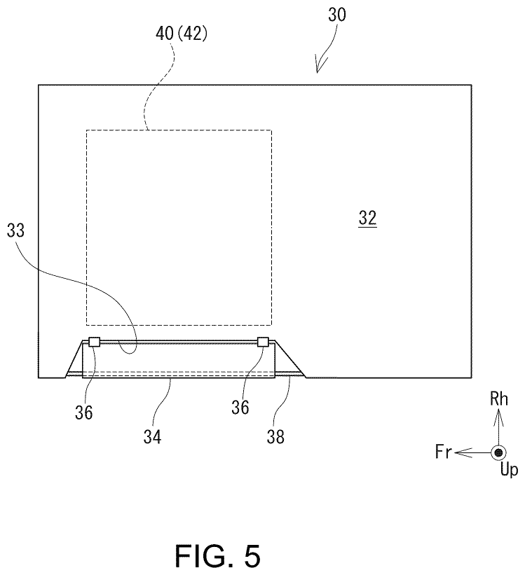

A structure of an electricity-driven vehicle 10 according to an embodiment of the present disclosure will now be described with reference to the drawings. FIG. 1 is a perspective diagram showing a region near a rear side door 12 of the electricity-driven vehicle 10, viewed from outside the vehicle. FIG. 2 is a schematic plan view of the electricity-driven vehicle 10. FIG. 3 is a cross-sectional diagram along an A-A line of FIG. 2, and FIG. 4 is a cross-sectional diagram along a B-B line of FIG. 2. FIG. 5 is a schematic diagram showing a relative placement of a deck board 30 and a battery loading portion 40. In the drawings, “Fr”, “Up”, and “Rh” respectively refer to a front side, an upper side, and a right side of the electricity-driven vehicle 10.

The electricity-driven vehicle 10 comprises a traveling motor (not shown), and a battery 44 which supplies electric power to the traveling motor. The electricity-driven vehicle 10 exemplified below is a commercial vehicle for transporting baggage. A rear seat of the electricity-driven vehicle 10 is removed, in order to improve a loading efficiency of the baggage. Therefore, an entirety of a rear side of a front seat 29 (not shown in FIG. 1; refer to FIG. 3) can be used as a baggage compartment. On a side of the electricity-driven vehicle 10, a front side door 11 and the rear side door 12 are placed, aligned in a front-and-rear direction. As shown in FIG. 2, the front side door 11 is a hinge door which swings about an axis extending in a vertical direction, and the rear side door 12 is a sliding door which slides in a vehicle front-and-rear direction. The rear side door 12 opens and closes a rear side door opening 14.

The battery 44 is a replaceable battery which can be easily replaced in the electricity-driven vehicle 10. The battery 44 is formed by housing a battery body formed from a plurality of unit cells in a housing. The housing of the battery 44 has, for example, a parallelepiped shape elongated in a vehicle width direction. A battery-side connector is provided at an end of the battery 44. When the battery-side connector is connected to a vehicle-side connector 46 to be described below, an electric power system equipped on the vehicle and the battery 44 are electrically connected with each other. The battery body is a secondary battery (for example, a lithium ion battery or the like) which can be charged and discharged. Therefore, the battery 44 which is removed from the electricity-driven vehicle 10 can be charged externally to the vehicle.

By setting the battery 44 as a replaceable battery in this manner, the usage efficiency of the electricity-driven vehicle 10 can be improved, and a demand peak of commercial electric power can be reduced. That is, when the battery 44 is of the replaceable type, after the battery 44 is removed from the electricity-driven vehicle 10, another battery 44 which is already charged can be mounted on the electricity-driven vehicle 10. Further, with such a configuration, because the electricity-driven vehicle 10 can travel even during a period in which a part of the battery 44 is charged, the usage efficiency of the electricity-driven vehicle 10 is improved. In addition, when the battery 44 is of the replaceable type, time of performing the charging operation can be freely selected, regardless of a usage situation of the electricity-driven vehicle 10. Because of this, the battery 44 can be charged during a time period of low demand of the commercial electric power (for example, at late night), and the demand peak of the commercial electric power can be reduced.

Such a battery 44 is mounted at a location where a user can easily replace the battery and where loading of the baggage is not obstructed. In the case of the electricity-driven vehicle 10 of the present disclosure, a battery loading portion 40 at which the battery 44 is loaded is provided at an adjacent position of the rear side door opening 14. The battery loading portion 40 will now be described in detail.

First, prior to the description of the battery loading portion 40, a basic vehicle body structure of the electricity-driven vehicle 10 will be described. The electricity-driven vehicle 10 has a vehicle body structure approximately identical to that of existing vehicles. By using the vehicle body structure of the existing vehicles as is, components and manufacturing processes can be made common with the existing vehicles, resulting in reduction of development and manufacturing costs of the electricity-driven vehicle 10. As shown in FIGS. 2 and 4, the electricity-driven vehicle 10 comprises a pair of side members 24 placed with a spacing in the vehicle width direction, and a plurality of cross members 26 connecting the pair of side members 24. Each of the side members 24 and the cross members 26 is a frame of the electricity-driven vehicle 10.

As shown in FIG. 4, at an upper side of the side member 24, a floor panel 16 is provided. The floor panel 16 is a steel plate panel forming a floor surface of a vehicle cabin. The floor panel 16 is welded to the frame (side member 24 or the like) of the electricity-driven vehicle 10. As shown in FIG. 3, at an immediately rear side of the front seat 29, a depressed portion 18 is present. The depressed portion 18 is a portion which extends in the vehicle width direction and which is depressed in a groove shape. In the case of the existing vehicles, a rear seat is placed at an immediately rear side of the depressed portion 18. As described above, in the case of the electricity-driven vehicle 10 of the present embodiment, the rear seat is removed.

At a laterally adjacent position of the depressed portion 18, the rear side door opening 14 is placed. As shown in FIG. 4, a lower end of the rear side door opening 14 is defined by a rocker 28. The rocker 28 is one type of a frame extending in the vehicle front-and-rear direction. In the present embodiment, as shown in FIG. 4, the battery loading portion 40 is provided at an upper side of the depressed portion 18. In addition, as shown in FIG. 2, the battery loading portion 40 is completely fitted within a width of the rear side door opening 14 in the front-and-rear direction. By employing such a configuration, the user can easily access the battery loading portion 40 through the rear side door opening 14.

The battery loading portion 40 is a part at which the battery 44 is loaded. The battery loading portion 40 has, for example, a battery casing 42. As shown in FIG. 4, the battery casing 42 is a container which houses one or more batteries 44 (in the illustrated example configuration, three batteries 44), and is a box approximately having a parallelepiped shape with one end in the vehicle width direction opened. The opening of the battery casing 44 at one end in the vehicle width direction serves as a loading port 48 through which the battery 44 is inserted and removed. When the battery 44 is to be replaced, the user accesses the battery casing 42 from a side of the electricity-driven vehicle 10 (in the illustrated example configuration, the left side), and inserts or removes the battery 44 via the loading port 48. As described above, in the present embodiment, the rear side door 12 is the sliding door. By employing the sliding door, interference between the battery 44 to be inserted or removed and the rear side door 12 can be effectively prevented, and workability when the battery 44 is replaced can be improved.

The loading port 48 is opened and closed by a casing lid 50. For example, the casing lid 50 swings with the center near a lower end of the loading port 48. As shown in FIG. 4, the casing lid 50 closes the loading port 48 when in a standing orientation approximately parallel with a perpendicular surface. When the casing lid 50 in the standing orientation swings downward, the loading port 48 is opened. By swinging the casing lid 50 about the lower end of the loading port 48 in this manner, a configuration is achieved in which, when the casing lid 50 is opened, the casing lid 50 does not interpose between eyes of the user (which are normally positioned above the loading port 48) and the loading port 48. With this configuration, the user can more easily see the periphery of the loading port 48, and, as a consequence, the workability when the battery 44 is replaced can be improved. In addition, in the case of the illustrated example configuration, a dimension of the casing lid 50 in the up-and-down direction is significantly smaller than the dimension of the casing lid 50 in the front-and-rear direction. Thus, by employing a configuration where the casing lid 50 opens downward, as compared with a case where the casing lid 50 opens laterally, an amount of protrusion when the casing lid 50 is opened can be set small. However, the structure of the casing lid 50 is not limited to the illustrated example configuration, and may be suitably changed. For example, the casing lid 50 may be changed to a laterally opening type, a double door type, or a sliding type.

In the battery casing 42, the connector 46 to be electrically connected to the battery 44 loaded in the battery casing 42 is provided. The battery 44 is electrically connected to an electric power system which is equipped in the vehicle, via the connector 46.

As shown in FIGS. 2 and 4, the battery loading portion 40 (that is, the battery casing 42) is fitted within a width between two side members 24 in the plan view. With such a configuration, when the electricity-driven vehicle 10 collides at the side, the side member 24 receives the impact before the battery loading portion 40. Because of this, damage to the battery 44 housed in the battery loading portion 40 is effectively prevented.

When the battery loading portion 40 is placed within the width between two side members 24, a vacant space in which nothing is placed is formed between one end of the floor panel 16 in the vehicle width direction and the loading port 48. In the following description, this vacant space between the floor panel 16 and the loading port 48 will be described as a “marginal space 17”.

As shown in FIG. 3, a height of the battery casing 42 is shorter than a depth of the depressed portion 18. The electricity-driven vehicle 10 further comprises a deck board 30 placed at an upper side of the floor panel 16 so as to cover and hide the depressed portion 18. In other words, the battery loading portion 40 is placed in a space surrounded by the deck board 30 and the depressed portion 18. As shown in FIGS. 2 and 3, the deck board 30 forms a flat floor surface, extending from a rear side of the front seat 29 to a rear end of the vehicle. By providing such a deck board 30, the entirety of the space behind the front seat 29 can be used as a baggage compartment, and thus, a transport efficiency of the baggage by the electricity-driven vehicle 10 can be improved.

The deck board 30 is not welded to any of the members of the electricity-driven vehicle 10, and can be removed from the electricity-driven vehicle 10 without destroying a component of the electricity-driven vehicle 10. By removing the deck board 30 from the electricity-driven vehicle 10 as necessary, maintenance or the like of the battery loading portion 40 can be easily performed.

As shown in FIGS. 2, 4, and 5, the deck board 30 comprises a body 32 and an overhang portion 34. The body 32 is a panel member which covers most part of the baggage compartment, except for the marginal region 17 described above. As shown in FIGS. 2 and 5, on the body 32, a cutout 33 is formed in an area which overlaps the marginal region 17 in a plan view.

The overhang portion 34 is a panel member which is placed at one end of the deck board 30 in the vehicle width direction, and which covers the marginal region 17 from above the marginal region 17. In other words, the overhang portion 34 is a panel member placed at the cutout 33. Therefore, as shown in FIG. 4, the overhang portion 34 extends to an outer side in the vehicle width direction in relation to the battery loading portion 40. In the example configuration of FIG. 4, the overhang portion 34 is connected to the body 32 via a hinge mechanism 36. With the hinge mechanism 36, the overhang portion 34 is swingable about an axis extending in the vehicle front-and-rear direction. Further, the overhang portion 34 is displaceable between a normal position at which the marginal region 17 is covered from above the marginal region 17, and a retracted position at which an area above the marginal region 17 is opened, through the swinging. In FIG. 4, the overhang portion 34 at the retracted position is illustrated with a solid line, and the overhang portion 34 at the normal position is illustrated with two-dots-and-chain line.

As shown in FIGS. 4 and 5, at an end of the cutout 33 at an outer side in the vehicle width direction, a support member 38 is provided, which is a rigid structure supporting the overhang portion 34 at the normal position from below the overhang portion 34. The support member 38 is, for example, a metal bar-shaped member extending across the cutout 33 in the vehicle front-and-rear direction.

As already described, the overhang portion 34 is displaceable between the normal position at which the marginal region 17 is covered from above the marginal region 17, and the retracted position at which the area above the marginal region 17 is opened. When the overhang portion 34 is positioned at the normal position, the baggage can be loaded also at the region above the marginal region 17. With this configuration, the loading efficiency of baggage of the electricity-driven vehicle 10 can be improved. Further, in the normal position, the overhang portion 34 is supported by the support member 38. Because of this, even when the baggage is heavy, flexure and damages of the overhang portion 34 can be prevented.

When the user replaces the battery 44, the user moves the overhang portion 34 to the retracted position. With such a configuration, the user can well check the periphery of the loading portion 48 without being obstructed by the overhang portion 34. Thus, with this configuration, the workability of the replacement of the battery 44 can be further improved.

There may be cases in which, during the replacement operation of the battery 44, the overhang portion 34 experiences some impact or vibration, and falls from the retracted position to the normal position. In order to prevent such unintended falling of the overhang portion 34, a latch mechanism which temporarily maintains a swinging angle of the overhang portion 34 may be provided on the hinge mechanism 36. For example, the hinge mechanism 36 may be a ratchet hinge that maintains the swinging angle with a predetermined angle interval, from the normal position to the retracted position.

In the structure in which the overhang portion 34 swings by the hinge mechanism 36 as shown in FIG. 4, it is necessary to completely move the baggage to the outer side of the overhang portion 34 before the overhang portion 34 is moved to the retracted position. In other words, in the structure of FIG. 4, the user must move the baggage prior to the replacement of the battery 44, which is cumbersome.

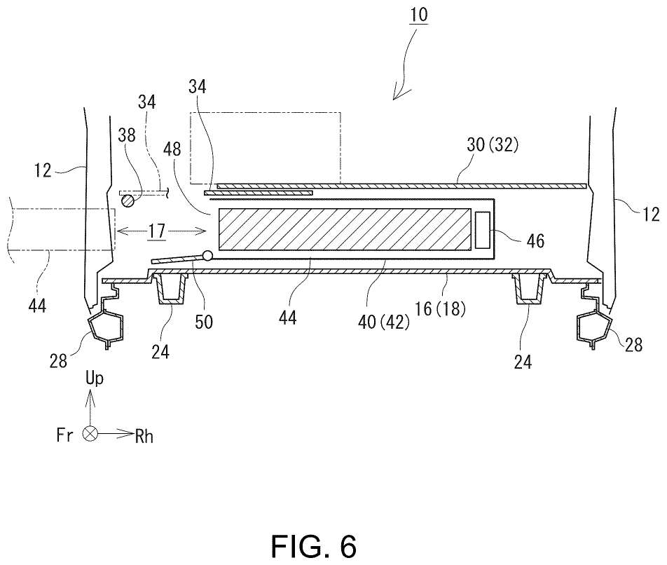

Thus, a configuration may be employed in which the overhang portion 34 can move to the retracted position without interfering with the baggage mounted on the deck board 30. For example, as shown in FIG. 6, a lower portion of the body 32 may be set as the retracted position. In this case, the overhang portion 34 moves to the retracted position through a sliding movement in the direction of the plane of the body 32. In this case, for example, a slide rail (not shown) is fixed to a back surface of the body 32, and a movable element (not shown) which moves along the slide rail is fixed to a front surface of the overhang portion 34. In this manner, by slide-moving the overhang portion 34, even when a part of the baggage extends into the marginal region 17, the overhang portion 34 can be moved to the retracted position. With this configuration, the battery 44 can be well replaced without moving the baggage.

In the above description, the overhang portion 34 is mechanically connected to the body 32 via the hinge mechanism 36 or the slide rail, and is not completely separated from the body 32. Alternatively, a configuration may be employed in which the overhang portion 34 is completely separable from the body 32. For example, the overhang portion 34 may be a panel member mounted on a periphery of the body 32 and the support member 38 in a manner to bridge therebetween.

The structures described above are merely exemplary, and, so long as the electricity-driven vehicle has the structure described in Claim 1, the other structures may be suitably changed. For example, in the above description, the rear side door 12 is described as a sliding door, but alternatively, the rear side door 12 may be a hinge door, similar to the front side door 11. Further, the structure of the battery loading portion 40 may also be suitably changed. For example, the shape and the size of the battery loading portion 40, and presence or absence of the casing lid 50 may be suitably changed.

### REFERENCE SIGNS LIST

10 electricity-driven vehicle, 11 front side door, 12 rear side door, 14 rear side door opening, 16 floor panel, 17 marginal region, 18 depressed portion, 24 side member, 26 cross member, 28 rocker, 29 front seat, 30 deck board, 32 body, 33 cutout, 34 overhang portion, 36 hinge mechanism, 38 support member, 40 battery loading portion, 42 battery casing, 44 battery, 46 connector, 48 loading port, 50 casing lid

1. An electricity-driven vehicle comprising:
a floor panel;
a deck board that is placed at an upper side of the floor panel;
a battery loading portion that is placed between the floor panel and the deck board;
one or more batteries of a replaceable type, that are inserted into and removed from the battery loading portion from a side of the vehicle;
a loading port that is provided at one end of the battery loading portion in a vehicle width direction; and
a lid that opens and closes the loading port, wherein
a marginal region is present between one end of the floor panel in the vehicle width direction and the loading port,
the deck board comprises:
a deck board body; and
an overhang portion which is placed at one end of the deck board in the vehicle width direction, and which extends to an outer side in the vehicle width direction in relation to the battery loading portion, so as to cover the marginal region from above the marginal region, and
the overhang portion is movable to a retracted position at which an area above the marginal region is opened.

2. The electricity-driven vehicle according to claim 1, further comprising:
a pair of side members that are placed with a spacing in the vehicle width direction, wherein
the battery loading portion is placed within a width between the pair of side members, and
the lid opens the loading port by swinging downward about an axis near a lower end of the loading port.

3. The electricity-driven vehicle according to claim 1, wherein
the overhang portion moves to the retracted position by sliding in a direction of a plane of the deck board.

4. The electricity-driven vehicle according to claim 1, wherein
the overhang portion is connected to the deck board body in a swingable manner, and moves to the retracted position by swinging upward.

5. The electricity-driven vehicle according to claim 1, wherein
the deck board further comprises a support member which is formed from a rigid structure, and which supports the overhang portion from below the overhang portion.
